(19) United States
(12) Patent Application Publication
(10) Pub. No.: US 2006/0025091 A1
(43) Pub. Date: Feb. 2, 2006

(54) Method for creating and using phrase history for accelerating instant messaging input on mobile devices

(75) Inventor: John Buford, Lawrenceville, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD, Osaka (JP)

(21) Appl. No.: 10/909,947

(22) Filed: Aug. 2, 2004

(51) Int. Cl. H04B 1/18

(52) U.S. Cl. 455/154.2

(57) ABSTRACT

Rapid instant messaging input is enabled through a system that displays frequently used or useful message phrases in a pop-up window from which the user may select a desired phrase to be inserted into the message stream. The system allows multiple phrase lists to be utilized and individual phrase messages are tagged with context information, allowing them to be selectively retrieved to provide only the most useful messages for a given context or scenario. The system automatically generates phrase lists by scanning the message stream data within instant messaging log files and the scanned information is then processed to select phrases for inclusion in the phrase list based on predefined heuristics.

### BACKGROUND OF THE INVENTION

The present invention relates generally to instant messaging and presence (IMP) systems. More particularly, the invention relates to an automated text entry system and method that collects and stores phrases that may be inserted into a messaging stream. Phrases are automatically extracted from a plurality of sources and are thereafter conveniently accessed from the user interface of the portable device.

Instant messaging and presence systems have become very popular in a wide variety of mobile devices, such as cell phones, smart phones, personal digital assistants (PDAs) and two-way pagers. Initially instant messages served the simple purpose of communication between two people. However, more recently, instant messaging and presence technology has evolved to handle more sophisticated functions such as interacting with data processing applications and control system applications. In these more sophisticated applications, the text of a message may serve as a command to initiate a database query, input data into a data processing application, or control the operation of a remote software system.

Despite the wide acceptance and potential power of instant messaging, there remains a significant problem that has not yet been adequately addressed. The problem: data entry on most mobile devices can be exceedingly difficult, due to the small size of those devices. First, devices with physical keyboards use miniaturized keys, placed in close proximity. These are difficult to use for typing. Second, devices with on-screen keyboards require a stylus or pointing device, limiting the speed of entry. Third, devices with keypads typically map the alphabet to numeric keys (numbering 10-12 keys). Thus multiple keystrokes are required for many characters.

Others have attempted to address the data entry problem through a variety of techniques. The word completion technique uses a dictionary and frequency model with selection predicted by the initial letters of the word entered by the user. Predictions may be wrong and the dictionary may grow to an excessively large size for resource-constrained mobile devices. Another character mapping technique involves mapping the most frequently used characters so that they are available for selection first. However, this requires the user to learn a new keypad assignment and to enter multiple keystrokes for characters that are not on the top 33 percent in frequency of usage. Although not particularly convenient for text message creation and editing, another technique for accelerating keyboard or keypad entry involves command history replay. Many command shells (such as those used to interact with the UNIX operating system) provide such a command history replay feature. The feature is limited to a providing replay of recently entered commands and is therefore not sufficiently flexible for instant messaging communication.

In addition to the aforementioned keyboard or keypad accelerating techniques, those systems which utilize a stylus and screen area for text entry often attempt to address the user interface problem by providing handwriting recognition. Some systems require the user to learn a specific handwriting style for character entry. Other systems employ more sophisticated handwriting recognizers. However, these recognizers still make frequent recognition errors, slowing the user down to make corrections.

### SUMMARY OF THE INVENTION

The present invention improves upon techniques attempted in the past. The invention uses a method that allows the user to more quickly enter words and phrases when sending instant messages. Key phrases are presented in a menu which the user can navigate while creating a message. Selecting the desired phrase from the menu causes the selected phrase to be inserted into the text message area which the user is editing, or alternately, to send the phrase directly as a message. The full power of the system and method derives from the manner in which phrases are collected, stored and used to facilitate instant messaging on portable devices. The system constructs and manages one or multiple phrase lists, each based on a different criteria, if desired. Phrases are added to the list in an automated fashion, with information for constructing the phrases coming from potentially multiple sources. One source involves text messages sent or received by the local instant messaging appliance, itself. Another source comes from the instant messages processed by buddies of the current instant messaging device's user. Yet another source of information flows from the instant messaging network through which all instant messaging users subscribe. The system is able to scan and distill from this information the most probably useful phrases which the user will then select by simple menu selection. The system is able to store not only the phrase text information but also a rich set of context data by which the stored phrases may be organized, filtered and retrieved for use in specific situations. The system can record both predefined context data and the user-defined context data. Predefined data might record context information such as who, what, when, where and why. User-defined context categories may also be created to address specific contextual situations that a particular user frequently encounters. If desired, the user-defined context criteria can be used singly or in combination with system-defined context information to create different context scenario “play lists” to cover specific uses the user may frequently encounter. Such uses include, for example, listing the user's favorite phrases or most frequently used phrases, or most frequently used phrases in a given session or in connection with some other qualifier.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. Accordingly, for a more complete understanding of the invention, refer to the remaining specification and to the accompanying drawings.

### BRIEF DESCRIPTION OF THE DRAWINGS

The present invention will become more fully understood from the detailed description and the accompanying drawings, wherein:

FIG. 1 is a block diagram presenting an overview of the manner in which the system and method are used to accelerate instant messaging input;

FIG. 2 is a flow chart diagram illustrating how the instant messaging screen is used to extract and store phrase text data and context data within a data store and thereafter accessed for selective presentation into the message stream;

FIG. 3 is a network-level diagram illustrating how the invention is able to use multiple sources of information in generating the phrase and context information stored by the system; and

FIG. 4 is an exemplary data structure diagram illustrating one embodiment of a data store for recording phrase message text and associated context data.

### DETAILED DESCRIPTION OF THE PREFERRED EMBODIMENTS

The following description of the preferred embodiment(s) is merely exemplary in nature and is in no way intended to limit the invention, its application, or uses.

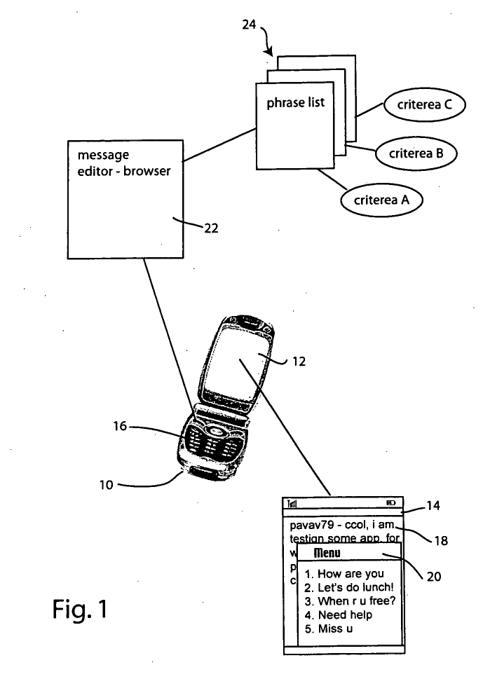

Referring to FIG. 1, the system and method for accelerating instant messaging input will now be described in an exemplary application involving a cellular telephone 10. It will be understood that the cellular telephone featured in FIG. 1 is merely intended to illustrate one possible use of the invention. In this regard, while the cellular telephone represents one example of a portable device with which the invention can be advantageously used, there is a wide range of devices that will benefit from the system and method described herein. Thus the illustration of a cellular phone should not be viewed as a limitation of the invention in its broader aspects.

The cellular telephone 10 includes a display 12 that can be used to display an instant messaging application such as the instant messaging chat application illustrated at 14. In this chat application, the user communicates with a buddy using text messages. The user types these messages by manipulating the keypad keys 16 and the ensuing text message dialog is presented on the screen as at 18.

In accordance with one aspect of the invention, when the user wishes to utilize the system or accelerating instant messaging input, he or she activates a predefined key on keypad 16 to call up an on-screen menu 20 containing a list of phrases from which the user may select. By selecting one of the phrases in a convenient fashion, such as by selecting its numerical index number, that phrase may be either inserted into the message text being entered by the user or simply sent directly as instant messaging text. As illustrated, menu 20 can overlap all or a portion of the screen containing the instant messaging text 18. Once the user has made a selection from the menu 20, the menu can be put away or removed from the screen so that the text message 18 can be seen in its entirety.

In the illustrated embodiment of FIG. 1, cellular phone 10 includes a message editor or browser software application 22 that is used to create the instant messages being composed by the user and is also used to display the text messages received from the user's, buddy. In this embodiment the editor has a local data store illustrated at 24 that may be partitioned into one or more phrase lists. If desired, each phrase list can be associated with a different criteria. In this way, the user can have different phrase lists constructed for different purposes. Examples include:
Favorite phrases created by the user.
Most frequently used phrases by this user, constructed by automatic analysis of instant messaging logs.
Most frequently used phrases by this user in previous sessions with the same buddy or group, constructed by automatic analysis of instant messaging logs.
Most frequently used phrases by all users in a given service provider domain, constructed by automatic analysis of instant messaging logs at the service provider, or from data extracted from instant messaging logs of users of the instant messaging service.

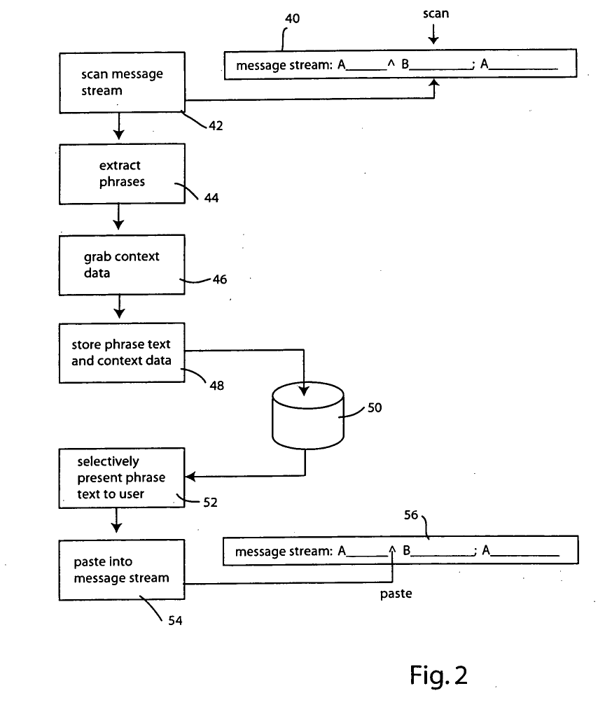

To generate the phrase lists used by the message editor or browser, several techniques are employed. One technique allows the user to predefine certain phrases and categorize those phrases according to predefined or user-defined contexts. In addition, the system also creates phrase lists automatically. An overview of the process for doing this is shown in FIG. 2.

Generally speaking, an instant messaging session among two or more users can be modeled as a message stream in which the individual message is sent by each user are serially organized and delimited in a manner to allow the message text from each user to be separated and displayed on successive lines of the instant messaging browser appliance. An exemplary message stream is illustrated at 40 in FIG. 2. These individual message streams, representing individual communication sessions, are typically stored in an instant messaging log file.

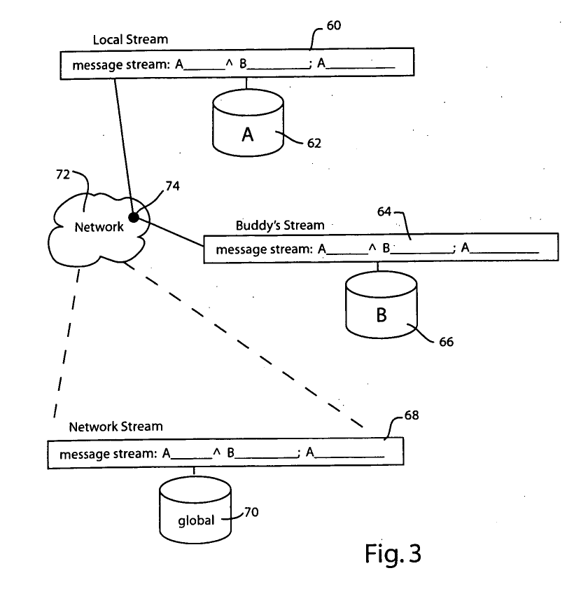

The system accesses the instant messaging log file and then scans the message streams as depicted at 42. The message streams are scanned to identify and extract candidate phrases (step 44) based on one or more information extraction models as will be more fully discussed below. In addition, as depicted at step 46, certain context data is obtained and then associated with the extracted phrases. The phrase text and context data are then stored at step 48 in a suitable data store 50. As will be discussed in connection with FIG. 3 below, the phrase extraction process and the data store can be performed and maintained on the local instant messaging device, or on some other device accessible through the instant messaging communication network.

Once stored in the data store, the phrase text may be selectively accessed and presented in the menu window 20 (FIG. 1) as depicted at step 52. The user then selects one of the presented phrases and instructs the message editor or browser to paste the selected text into the message stream as depicted at step 54 and the diagrammatic representation of the message stream at 56. Depending on the wishes of the user, the inserted phrase can either be included in a message text being created for later sending, or the phrase text may be sent immediately as the next instant message to the other participating party or parties. In the former case, the phrase text is simply inserted into the text stream without any send command being issued. In the latter case, the phrase text is inserted and then followed by a send command, causing the inserted text to be immediately sent.

Referring now to FIG. 3, it will be seen that the system and method of the invention is capable of deriving phrase text information from a plurality of disparate sources. In this regard, FIG. 3 illustrates three message streams: a local stream 60, having an associated data store 62; a buddy stream 64, having an associated data store 66; and a network stream 68 having a global data store 70. Each of these streams may be obtained by either monitoring live instant messaging communications or by subsequently accessing the associated instant messaging log file containing the message stream data.

FIG. 3 illustrates the case where user A is communicating with buddy B through the services of the instant messaging network infrastructure 72. Parties A and B are currently participating in an instant messaging session depicted diagrammatically at 74. By virtue of using the infrastructure 72, the instant messaging session 74 between parties A and B may provide phrase text data and context data to a global log maintained by a third party, such as the instant messaging service provider that controls the infrastructure 72. Thus information contained within party A's local stream 60 and party B's buddy stream 64 become part of the network stream 68 and may thus be stored in the global data store 70.

The process described in FIG. 2 is capable of utilization on any message stream, including the local message stream 60, B buddy's stream 64 and the network stream 68. In one embodiment, the information extraction process of FIG. 2 may be carried out by the user instant messaging appliances or by some other computer system coupled to the infrastructure 72. In one embodiment, party A's instant messaging appliance is responsible for performing the process of FIG. 2 upon the local stream 60. Results of the processing are then stored in data store 62, which is maintained by party A's instant messaging appliance. Similarly, the buddy stream 64 would be processed by the instant messaging appliance of party B, and the results of this processing would be stored in data store 66 resident on party B's instant messaging appliance. Likewise, the network stream 68 would be processed using the techniques described in FIG. 2, with the results stored in the global data store maintained by the third party (e.g., service provider).

Once the information has been extracted and stored at one or more of the locations illustrated in FIG. 3, the user may access the phrase lists through the convenient menu 20 illustrated in FIG. 1. There are several ways to route the information to the user's information appliance. Phrase text and associated context data that are collected and processed locally the user's information appliance may be directly accessed by that appliance by simply accessing the local data store 62. Information harvested from the Buddy's stream or from the network stream may be passed to the user's information appliance in a variety of ways. In one way, the user's information appliance accesses the buddy's data store 66 and/or the global data store 70 during the instant messaging session, loading selected portions of data from these data stores into local memory for use during that messaging session only. Another way involves loading selected data from data store 66 and/or data store 70 at periodic intervals not necessarily tied to an ongoing instant messaging session.

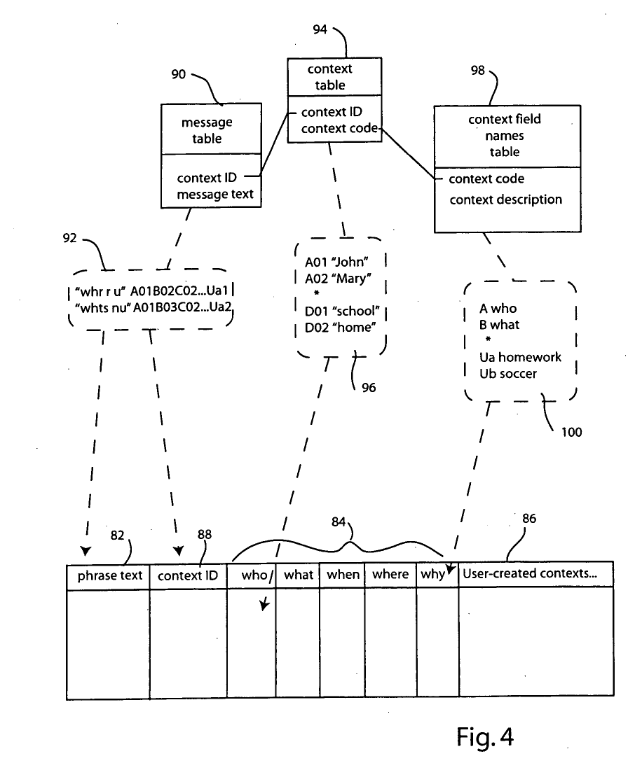

Using the information extraction process illustrated in FIG. 2 and the information architecture illustrated in FIG. 3, the system is able to collect and organize a rich corpus of phrase information that may be useful in accelerating instant messaging input. Two prevent the user from being overwhelmed with too many choices, the system includes a sophisticated information tagging mechanism that allows text information to the selectively and grouped and/or filtered based on a variety of different context data. Essentially, each phrase has a set of associated context data that may be used to classify the phrases so that only the appropriate ones for a given context will appear in the menu window 20 (FIG. 1). There are a variety of different ways to configure the data stores to implement this. For purposes of illustrating the concept, FIG. 4 shows one possible data structure. Those skilled in the art will appreciate that there are many ways to configure a database schema to store the phrase text and context information. Thus the exemplary data store architecture of FIG. 4 is intended merely as a teaching example.

Referring to FIG. 4, one can first consider the data store in a flat file view shown at 80. In this view the phrase text column 82 stores individual phrase text strings extracted using the process of FIG. 2. Associated with each entry in this column are a plurality of context attributes. For illustration purposes, a set of system-defined context attributes are illustrated at 84 and a set of user-created contexts are illustrated at 86. If desired, the collection of context attributes 84 and 86 for a given line in the data table may be assigned a context ID 88.

By associating context information with each string of phrase text, the system can selectively filter out and display only phrase text entries that meet a particular set of attributes. By defining different scenarios having particular sets of attributes, the user can readily call up a customized list of phrase text entries to match whatever scenario the user is currently interested in. Examples of some common scenarios are provided later below.

The flat file representation at 80 is useful in understanding how multiple context attributes may be associated with a given phrase text string. In an actual implementation, a relational database (as opposed to a flat file) may be used to implement the data store. For purposes of illustration, a three table relational structure is featured in FIG. 4. The message table 90 contains the phrase text string data along with a context ID associated with each text string. An example of the data stored in table 90 has been provided at 92. Note that each entry in table 92 includes a message portion (“whr r u”) and a context ID portion (AO1BO2CO2 . . . . Ua1). The context ID serves as a key for linking table 90 to the context table 94. An example of the data stored in context table 94 has been provided at 96. The context table stores individual context data items, linking each item to a portion of the context ID. Thus in the illustrated example the context data AO1 refers to the person “John.” The letter A in the context ID relates to a context field name, in this case the “who” field name shown in flat file table 80. The field names may be decoded using the third table 98. Table 98 is linked by a context code, corresponding to the letters A, B, C, D, etc. Table 98 provides the context description associated with each code. An example of the data stored in table 98 is shown at 100. Within the table 100 both system-defined context and user-created contexts have been illustrated. For purposes of this illustration, the context A “who” and B “what” are system-defined contexts. The contexts Ua “homework” and Ub “soccer” are user-created contexts. Using the relational table structure of FIG. 4, or its functional equivalent, the system is able to store context information about each text phrase, and this context information can include user-created contexts.

The system and method for accelerating instant message input readily adapts to a number of different scenarios. The following are presented as examples.

Scenario: Favorite Phrases

The user can create and edit his or her favorite phrase list. These phrases appear in the favorite phrases menu or list displayed in the menu window 20 (FIG. 1). In this scenario the list of phrases can be either typed by the user in advance or selected from other phrase lists. These other phrase lists may themselves either be directly typed by the user or generated through the automatic mechanism described above.

Scenario: Most Frequent Phrases

Initially before the user has participated in any instant message sessions, there are no phrase lists based on frequency. Each time the user participates in an instant message session, the phrase list can be created (first time) or updated (as discussed more fully below). As each session is completed, the most frequent phrase list can be updated. Alternately, the most frequently phrase list could be updated during each session by immediately merging each phrase as it is sent into the most frequent phrase list and update the contents and frequencies at that time. Referring to FIG. 2, the extraction of phrases based on frequency is performed at step 44.

Scenario: Most Frequent Phrases by Session or Other Qualifier

A set of phrases can be distinguished by many attributed, represented by the context data. The context data may include attributes such as participants, time window or time of day, and related event context as noted in the user's calendar. Other context data may also be used as discussed generally in connection with FIG. 4. Utilizing context data recognizes that communication is highly contextualized, such that patterns of communication occur in related context. The user can select instant messaging contexts of interest for use in a given instant messaging session, or as part of a user profile. The system which processes the instant messaging logs to produce the phrase lists is configured, as shown in FIG. 2, to acquire context data and store it in association with the phrase text.

Scenario: Short Messages as Idioms

Another technique is to process only those messages whose text length is less than a certain length (e.g., ten characters), with the strategy that these short messages are most likely to be instant messaging idioms. Examples of such idioms are “hw r u?”, “whts nu”, “bye” and so forth. For this scenario the extract phrases step 44 of FIG. 2 would include a text length assessment operation to identify those phrases which meet the length requirement.

Further Details of Phrase List Creation

As noted above, the user can create local phrase lists in different ways. These include editing a list directly on the instant messaging device, creating a phrase list on a desktop computer and downloading it into the device, or creating it using a web interface and then transferring it to the device. The user can transfer phrase lists between devices that he or she uses, or the user may exchange phrase lists with other users. An instant messaging service provider can also provide phrase list storage on the instant messaging provider servers for its users. This latter capability is illustrated in FIG. 3. The global data store 70 would be used for this purpose.

The user can directly edit a phrase list which is a sequence of text phrases. Subject to system limits, the user is thus able to determine each phrase, its length, character set, position in the phrase list and number of phrases in the list.

As previously noted, the generation of phrase lists by automatic processing of the instant messaging session logs can be performed on the local device, on another party's device, on a computer at the service provider or on another computer such as a computer operated by the user of the instant messaging appliance. The processing can be done on the same device or system where the session logs are captured, or the logs can be transferred to another system or device for processing. Thus referring to FIG. 3, the local stream data 60 would be stored in a local instant message session log and that session log might be uploaded to the network and then subsequently processed by a computer on the network, with the results then transferred back to the local device.

An instant messaging session log contains a sequence of the ID of the sender and the text of the message in chronological order. Thus a possible phrase extraction algorithm consists of these steps:
1. Extracting all phrases in the text messages;
2. Optional coalescence of phrases which are similar according to some heuristic;
3. Optional elimination of phrases which are deemed not usable by some heuristic;
4. Counting the occurrence of the unique phrase;
5. Ordering the unique phrase list by decreasing frequency of occurrence.

Pseudo code of this algorithm is as follows:

CreatePhraseList(MessageLog ml) {

For each Message m in ml do ExtractPhrases(Message m, List p1);
For each Heuristic h in h1 do

CoalesceSimilarPhrases(List p1, List p2, Heuristic h);
p1 = p2

For each Heuristic h in h2 do

EliminateUnusablePhrases(List p2, List p3, Heuristic h);
p2 = p3

InsertCounts(List p3, List p4);
Sort(List p4, List p5);
Return p5; // phrase list

}
ExtractPhrases(Message m, List p1) {

// messages shorter than some length are idioms
If (m.length < idiom_max_length) {

p1.add(m);
return;

}
ExtractSentences(Message m, List s); // or sentence fragements
For each member of s:

ParseSentencesIntoPhrases(s, p);
Append(p, p1); // p contains one or more phrases

}
/* possible heuristics: spelling errors, similar prepositions,
similar nouns, mapping all nouns & verbs to root words */
CoalesceSimilarPhrases(List p1, List p2, Heuristic h) {

For each phrase in p1

If (h==RootMapping) replace all words with root synonym
// other heuristics ...

}
//unusable phrases could be too long, contain one or more long
// words, contain words that aren't in the system's dictionary, ...
EliminateUnusablePhrases(List p2, List p3, Heuristic h2) {

For each member in p2

If (usable(p2.next, h2)) p3.add(p2);

}
InsertCounts(List p3, List p4) {

sort(p3, p5); // this puts duplicates in adjacent positions
for i=0 to p5.length

p4[j] = p5[i] // first occurrence has count = 1
p4.count = 1
k = 1;
// eliminate dups, increment count

while p5[i+k] == p5[i]

p4.count ++;
k++;

i = i + k;
j++;

}

The resulting phrase list contains a sequence: phrase, occurrence count, frequency in the instant messaging log. The phrase list may have additional information, including: file name of instant messaging session log, date of session, participants in session. The phrase list for a set of instant messaging session logs can be combined:
1. Select the phrase lists to be combined;
2. Merge the unique phrases, adding their counts;
3. Optionally coalesce phrases which are similar according to some heuristic;
4. Optionally eliminate phrases which are deemed not usable by some heuristic;
5. Recalculate the frequency of each phrase using the updated counts;
6. Order the merge to phrase list by decreasing frequency of currants.

The pseudo code for this algorithm follows:

MergeLists(List master, List a) {

master = a.next
for each member of a

merge(master, a);

for each Heuristic h in h1 do

CoalesceSimilarPhrases(List p1, List p2, Heuristic h);
p1 = p2

for each Heuristic h in h2 do

EliminateUnusablePhrases(List p2, List p3, Hueristic h2);
p2 = p3

UpdateFrequencies(master)
Sort(master)

}

The resulting merged phrase list contains a sequence: phrase, occurrence count, frequency of occurrence in the merged sessions. The phrase list may have additional information, including file name of each original instant messaging session log, date of each session, participants in each session.

The selection of a combination of phrase lists to merge allows the creation of phrase lists meeting various criteria, including but not limited to:
Phrase lists from sessions between specific users;
Phrase lists at specific times or time windows;
Phrase lists from sessions from specific devices the user uses;
Phrase lists from sessions using specific service providers.

Each phrase list can be aged. Entries based on instant messaging logs prior to a specific time window (e.g., thirty days) can be eliminated from the frequency. This allows the user's phrase list to adjust to changes in message patterns that occur over time.

While the foregoing has illustrated the principles of the invention in the context of a text-based message, it will be understood that the techniques are applicable to any language, both alphabetic and ideographic. In addition, the techniques can be applied to both short message service (SMS) systems and multimedia service (MMS) as well as e-mail text entry. The invention can be used on desktop computers and other computing devices besides mobile devices. It can be used on any device which is equipped with instant messaging, SMS, MMS or similar client software. Moreover, the invention can be used on other appliances that have some form of alphanumeric keypad (or an analog to such keypad) such as telephones and remote controls.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for creating instant messages comprising:
scanning a first message stream to extract phrase text information from said first message stream;
storing said extracted phrase text information in a data store;
presenting said stored phrase text information to a user for selection and placement into a second message stream.

2. The method of claim 1 further comprising acquiring context data and storing said context data in association with said extracted phrase text information.

3. The method of claim 1 wherein said first message stream is obtained from a message log file.

4. The method of claim 1 wherein said stored phrase text information is selectively presented to a user in a list structure displaying on a display of an instant messaging appliance.

5. The method of claim 1 wherein said stored phrase text information is selected by said user and inserted into said second message stream.

6. The method of claim 1 wherein scanning of said first message stream is performed by an instant messaging appliance.

7. The method of claim 1 wherein scanning of said first message stream is performed by an instant messaging appliance operated by said user.

8. The method of claim 1 wherein scanning of said first message stream is performed by an instant messaging service provider.

9. The method of claim 1 wherein scanning of said first message stream is performed by a system coupled to an instant messaging network.

10. The method of claim 1 further comprising storing said extracted phrase text information as plural lists.

11. The method of claim 1 further comprising storing said extracted phrase text information as plural lists, at least some of said lists being associated with different contexts.

12. The method of claim 1 wherein said data store is associated with an information appliance.

13. The method of claim 1 wherein said data store is associated with an instant messaging service provider.

14. The method of claim 1 wherein said data store is associated with a system communicating with an instant messaging network.

15. The method of claim 1 wherein said scanning step extracts phrase text information based on a predetermined phrase extraction algorithm.

16. The method of claim 15 wherein said algorithm extracts all phrases in the text of an instant message.

17. The method of claim 15 wherein said algorithm coalesces phrases which are similar according to a predefined heuristic.

18. The method of claim 15 wherein said algorithm eliminates phrases which are deemed not usable by a predefined heuristic.

19. The method of claim 15 wherein said algorithm generates a unique phrase list, counts the occurrence of each unique phrase in said list and orders the list based on frequency of occurrence.

20. The method of claim 1 further comprising acquiring context data according to predetermined context identifying criteria and storing said context data in association with said extracted phrase text information.

21. The method of claim 20 wherein said predetermined context identifying criteria encompasses a user-defined context.

22. The method of claim 1 wherein said stored phrase text information is selectively presented to said user based on a predefined presentation criteria.

23. The method of claim 22 wherein said presentation criteria encompasses a favorite phrase list created by the user.

24. The method of claim 22 wherein said presentation criteria encompasses a most frequent phrase list created based on frequency of occurrence information.

25. The method of claim 24 wherein said frequency of occurrence information corresponds to a single instant messaging session.

26. The method of claim 24 wherein said frequency of occurrence information corresponds to a plural instant messaging sessions.

27. The method of claim 22 wherein said presentation criteria encompasses a most frequent phrase list created based on frequency of occurrence information across plural users.
